(19) United States
(12) Patent Application Publication
(10) Pub. No.: US 2012/0105982 A1
(43) Pub. Date: May 3, 2012

(54) ROLLABLE BASE WITH ELECTRONICS AND POWER SUPPLY

(75) Inventor: Stephen J. Sullivan, Redmond, WA (US)

(73) Assignee: Gynex Corporation, Redmond, WA (US)

(21) Appl. No.: 12/915,913

(22) Filed: Oct. 29, 2010

(51) Int. Cl. G02B 23/16

(52) U.S. Cl. 359/811

(57) ABSTRACT

An optical system having a scope device includes a post extending from a rolling base. Electronic components for communicating with the scope device are located either underneath the base with appropriate clearance from the floor or within a cavity formed in the base. In one embodiment, the base includes a plurality of legs each having a roller or caster attached thereto. At least one of the legs may include a channel or passageway for routing an electrical power cord such that the cord extends out from a distal end of the leg. Further, an ON/OFF switch may be located on one of the legs such that one or more features of the optical system may be turned on or off by foot.

### FIELD OF THE INVENTION

This invention relates generally to an optical system with an electronic pod or box placed under or within a rollable base and a power supply extending from a distal point of the base.

### BACKGROUND OF THE INVENTION

FIG. 1 shows a conventional colposcope 10 having an optics assembly 12 supported on an adjustable pole or post 14. Such scopes 10 are commonly provided with an electronic pod or box 16 attached to the pole 14 at a distance above a movable base 18 that includes rollers or casters 20. The box 16 typically includes various electronics such as, but not limited to, rheostats, controllers and LED lights. Power from an A/C outlet (not shown) is supplied to box 16 by means of power cord 22. Although a colposcope 10 is illustrated, it is appreciated that other types of scopes have a similarly located electronic box 16 and power cord 22. Such other scopes may include, but are not limited to, different types of colposcopes, microscopes, ear-nose-throat (ENT) scopes, and dental scopes.

Conventional scopes in the medical, dental and laboratory fields typically have the electronic pod mounted on the pole or an articulating arm extending from the pole. With the pod mounted on the pole, it can be a common occurrence for the doctor to bump the pod with knees or elbows while performing procedures on a patient. In addition, the location of the pod on the pole tends to raise the center of mass for the optical system, which in turn can make the entire system a bit top heavy and prone to tipping or wobbling when moved, especially across an uneven surface.

### SUMMARY OF THE INVENTION

An optical system having a scope device includes a post extending from a rolling base. Electronic components for communicating with the scope device are located either underneath the base with appropriate clearance from the floor or within a cavity formed in the base. In one embodiment, the base includes a plurality of legs each having a roller or caster attached thereto. At least one of the legs may include a channel or passageway for routing an electrical power cord such that the cord extends out from a distal end of the leg. Further, an ON/OFF switch may be located on one of the legs such that one or more features of the optical system may be turned on or off by foot.

In one aspect of the invention, a rollable, electronically-powered optical system includes a base and a pod. The base may have legs, no legs or take some other desired shape. The pod is attached to the base and defines a cavity for receiving electronic equipment, which is in communication with a scope of the optical system, and where the scope is located above the base.

In one aspect of the invention, a rollable, electronically-powered optical system having a scope includes a base having a plurality of legs; a plurality of rolling members corresponding to the plurality of legs and coupled respectively thereto; and a pod attached to an underside of the base, the pod defining a cavity for receiving electronic equipment, the equipment being in communication with the scope of the optical system, the scope located above the base.

In another aspect of the invention, a rollable, electronically-powered optical system includes a molded upper base portion having a plurality of legs; a plurality of rolling members corresponding to the plurality of legs and coupled respectively thereto; and a molded lower base cover attachable to an underside of the upper base portion, the upper base portion and the lower base cover cooperating to define a cavity for receiving electronic equipment in communication with a scope located above the upper base portion.

### BRIEF DESCRIPTION OF THE DRAWINGS

Preferred and alternative embodiments of the present invention are described in detail below with reference to the following drawings.

FIG. 1 is a perspective view of a conventional colposcope found in the prior art;

FIG. 2A is an exploded, perspective view of a lower portion of an optical system having a electronic pod located underneath a rollable base of the system according to an embodiment of the present invention;

FIG. 2B is a perspective view of the lower portion of the optical system of FIG. 2A showing the electronic pod attached beneath the rollable base according to an embodiment of the present invention;

FIG. 3 is side elevational view of an electronic pod with a tapered upper surface according to an embodiment of the present invention;

FIG. 4 is side elevational view of the lower portion of the optical system of FIG. 2B according to an embodiment of the present invention;

FIG. 5 is a perspective view of molded, rollable base having a power cord and an ON/OFF switch according to an embodiment of the present invention;

FIG. 6 is an exploded, perspective view of the rollable base of FIG. 5 showing a lower base portion detached from an upper base portion;

FIG. 7 is an exploded, side elevational view of the rollable base of FIG. 6; and

FIG. 8 is a bottom, plan view of the rollable base of FIG. 5.

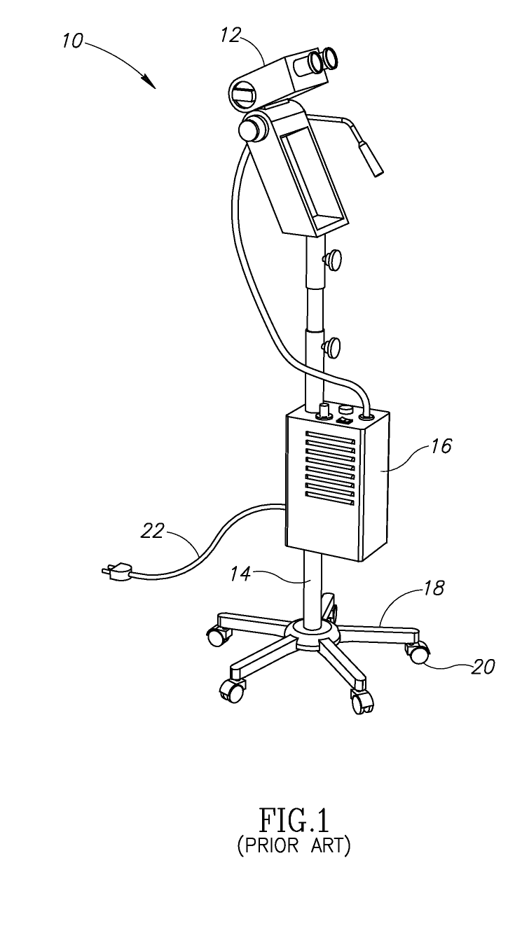

### DETAILED DESCRIPTION OF THE PREFERRED EMBODIMENTS

The present invention generally relates, but is not limited, to an optical system having a scope or other instrument supported by a pole extending from a movable, and preferably a rolling, base. The scope includes an electronic pod configured so that it can be mounted underneath the base and further includes wiring or cables extending from the pod into the pole. Additionally or alternatively, the scope may include a power supply that extends from the pod, through a leg of the rolling base, and out a distal end of the leg such that the power supply may be less likely to interfere with the base when it is rolled or otherwise moved over a surface.

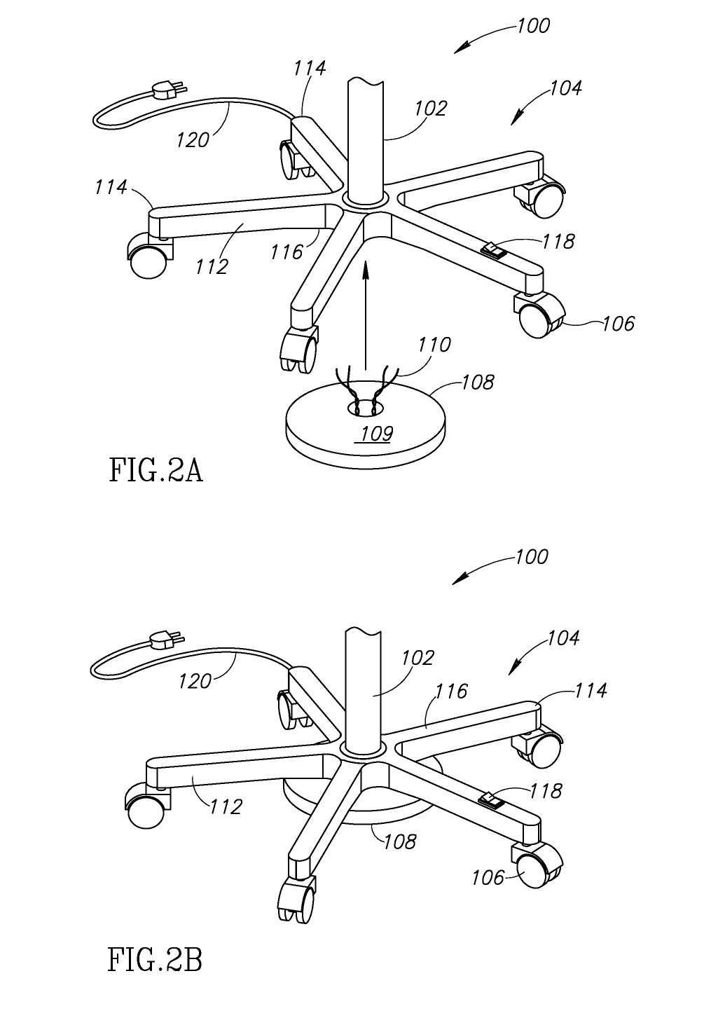

FIGS. 2A and 2B show a lower portion 100 of an optical system or other medical instrument having a center post 102 supported by a rolling base 104. In the illustrated embodiment, the rolling base 104 takes the form of a star-wheeled base having a plurality of rollers, wheels or casters 106. However, the rolling base 104 may take other forms, to include a non-rolling base such as a track-guided base or sliding base. An electronic box or pod 108 is mounted beneath the base 104. The pod 108 includes wires or cables 110 that extend into the post 102 for communication with electronic and/or optical equipment that may be handled by a doctor or nurse, for example to operate the scope.

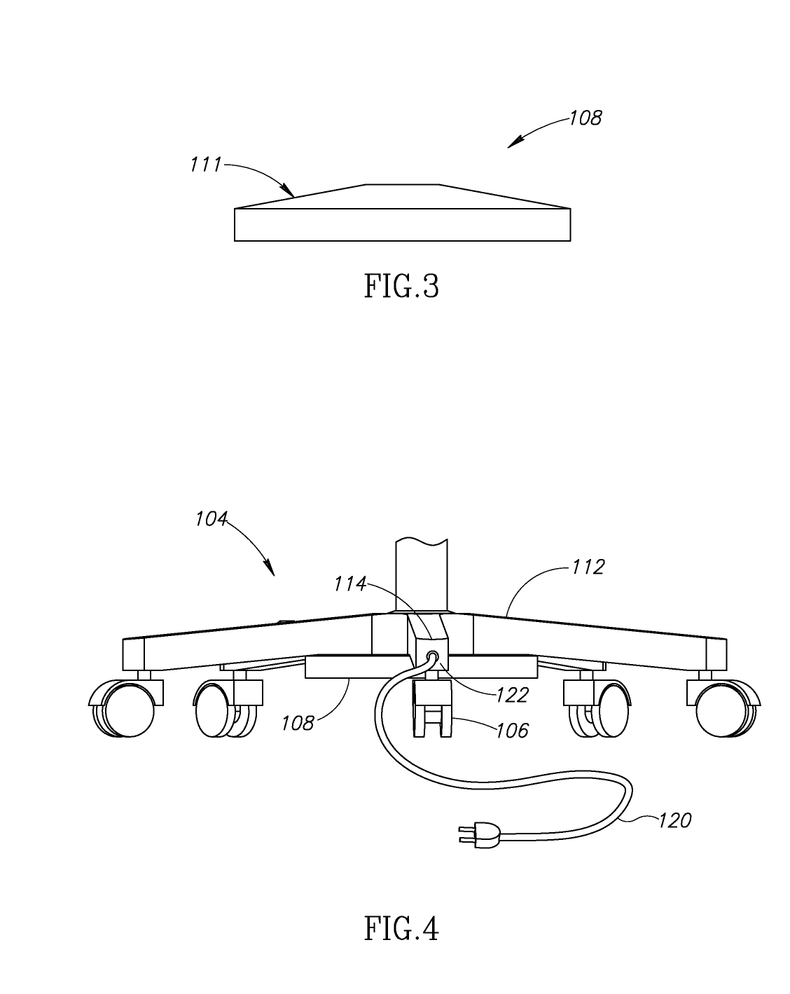

In the illustrated embodiment, the pod 108 takes the form of a disk, which may have substantially planar upper and lower surfaces 109 or tapered surfaces 111, the latter best shown in FIG. 3. With the pod 108 located underneath the base 102, the electronics and pod structure provide additional mass to the base, which in turn may vertically lower a center of mass of the system making it less likely to tip, rock or behave in a top heavy manner.

Still referring to FIGS. 2A and 2B, the rolling base 104 includes legs 112 each having a distal end 114 and a proximal end 116, each with respect to post 102. An ON/OFF switch 118 is coupled to one of the legs 112 and may be activated by foot. A power cord 120 extends from one of the legs 112.

FIG. 4 shows the power cord 120 extending from an end surface 122 of the leg 112. The power cord 120 is routed through a channel or passageway formed by the leg 112 to provide electricity to the electronic components in the pod 108. One advantage of routing the cord 120 through the leg 112 and out the end surface 122 at the distal end 114 is to minimize or prevent the cord 120 from being tangled with or run over by the rollers 106. In one embodiment, the power cord 120 takes the form of a retractable power cord and optionally a retract mechanism for the retractable cord may be located within the pod 108.

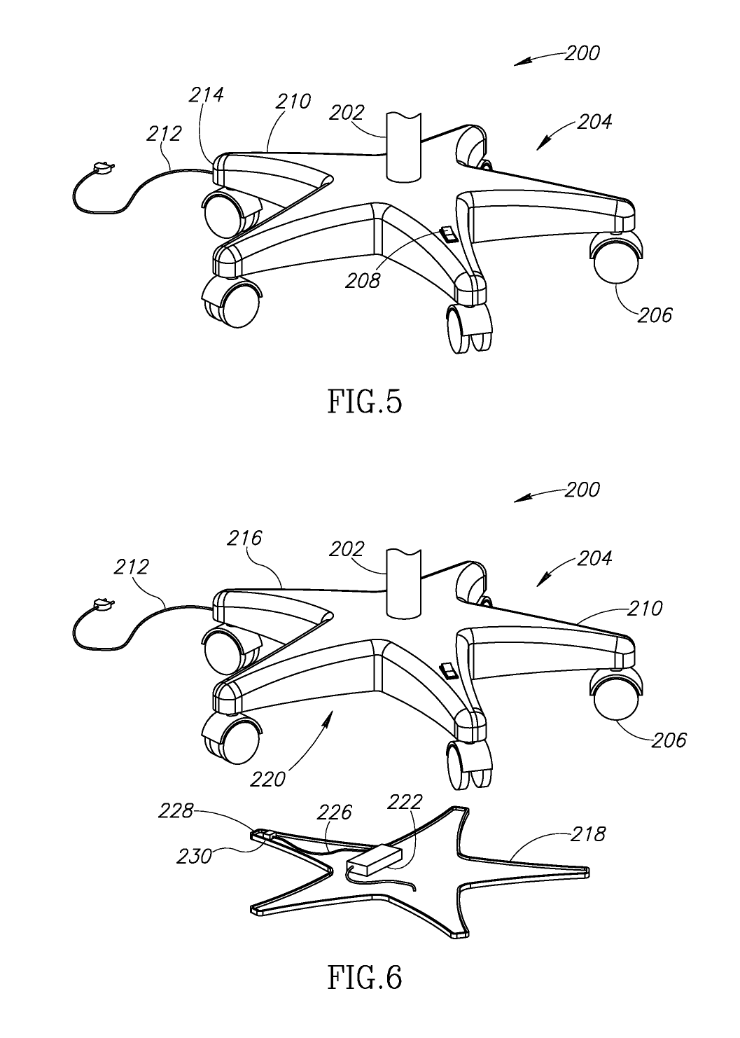

FIGS. 5-8 show a lower portion 200 for an optical system according to another embodiment of the present invention. The similarities with the aforementioned embodiment will be briefly mentioned, but not described in detail for the sake of brevity and clarity. The lower portion 200 includes a center post 202 supported by and extending from a rolling base 204, which again takes the form of a star-wheeled base having a plurality of rollers, wheels or casters 206. A foot operable ON/OFF switch 208 is located on one of the legs 210 of the base 204. Also, a power cord 212 is routed through one of the legs 210 and extends from a distal end 214 of the respective leg 210.

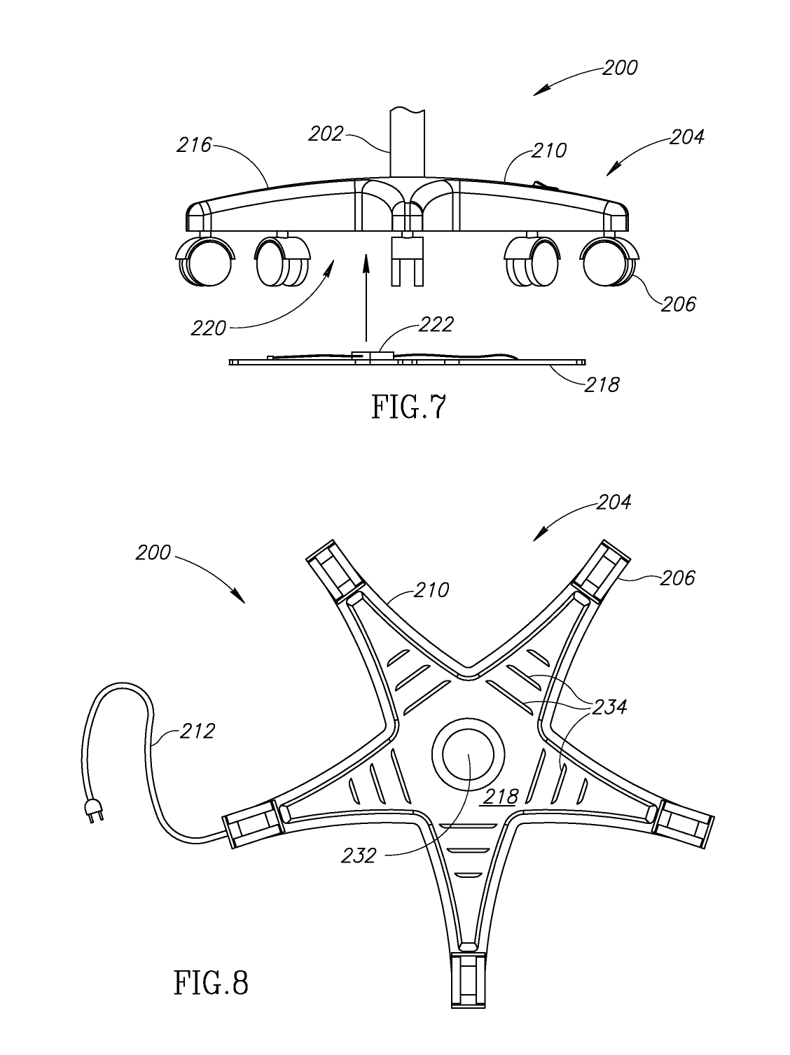

Now referring to FIGS. 6-8, the base 204 is a two-part base having a base upper 216 and a base lower 218 that when coupled together form a cavity 220 (FIG. 7) in which electronic or other components 222 may be located. The base lower 218 may be configured to have a complimentary shape with respect to the base upper 216, as illustrated with the star pattern. However, such a complementary shape is not required as the base lower 218 may take other shapes. Wires or cables 224 extend from the electronic component 222 into the center post 202 to provide electronic communication with the scope or other devices of the system. The base lower 218 may be attached to the base upper 216 with fasteners, clips, magnetically, or by other means. A power cord 226 extends from the electronic component 222 through the channel formed in the leg 210 by the cavity 220. Before the power cord 226 exits a distal end 228 of the leg 210, the cord 226 may be secured with a boss or tie-down device 230.

In one embodiment, the base upper 216 and base lower 218 are molded, plastic components. FIG. 8 shows a center portion 232 of the lower base 218 may be structurally reinforced to mount and seat the center post 202. The base 204 would be hollow and the electronic components 222 would fit within the cavity 220. This arrangement may be advantageous as it would essentially hide the electronic components 222 from visible sight. The base lower 218 may include vents 234, which may take the form of apertures, slots or other openings to permit air circulation within the cavity 220 (FIG. 7).

While the preferred embodiments of the invention have been illustrated and described, as noted above, many changes can be made without departing from the spirit and scope of the invention. Accordingly, the scope of the invention is not limited by the disclosure of the preferred embodiments. Instead, the invention should be determined entirely by reference to the claims that follow.

The embodiments of the invention in which an exclusive property or privilege is claimed are defined as follows:

1. A rollable, electronically-powered optical system having a scope, the system comprising:
a base; and
a pod attached to the base, the pod defining a cavity for receiving electronic equipment, the equipment being in communication with the scope of the optical system, the scope located above the base.

2. The system of claim 1, further comprising a plurality of legs coupled to the base and extending substantially laterally therefrom.

3. The system of claim 2, wherein each leg includes a leg body extending between a proximate portion and a distal portion, the proximate portion located closer to the base.

4. The system of claim 2, further comprising a plurality of rolling members corresponding to the plurality of legs and coupled respectively thereto.

5. The system of claim 1, further comprising a power cord in communication with the electronic equipment in the pod, the power cord extending from a distal portion of one of the legs.

6. The system of claim 1, wherein the pod is attached to an underside of the base.

7. The system of claim 1, further comprising an ON/OFF switch located on one of the legs to be operated by foot.

8. The system of claim 1, wherein the pod is disc-shaped.

9. The system of claim 1, wherein the pod includes an opening aligned with a hollow pole supported by the base.

10. The system of claim 4, wherein the rolling members are casters.

11. The system of claim 1, wherein the base is a five star caster base.

12. A rollable, electronically-powered optical system having a scope, the system comprising:
a base having a plurality of legs;
a plurality of rolling members corresponding to the plurality of legs and coupled respectively thereto; and
a pod attached to an underside of the base, the pod defining a cavity for receiving electronic equipment, the equipment being in communication with the scope of the optical system, the scope located above the base.

13. A rollable, electronically-powered optical system comprising:
a molded upper base portion having a plurality of legs;
a plurality of rolling members corresponding to the plurality of legs and coupled respectively thereto; and
a molded lower base cover attachable to an underside of the upper base portion, the upper base portion and the lower base cover cooperating to define a cavity for receiving electronic equipment in communication with a scope located above the upper base portion.

14. The system of claim 13, wherein the upper base portion and the lower base cover are complementarily shaped.

15. The system of claim 13, wherein the lower base cover includes a vent configured to permit air circulation within the cavity.

16. The system of claim 13, further comprising a power cord routed through a channel formed in one of the legs.

17. The system of claim 16, wherein the power cord extends from a distal portion of one of the legs.

18. The system of claim 13, further comprising a foot operated ON/OFF switch located on one of the legs,

19. The system of claim 13, wherein the lower base cover includes a structurally reinforced region for supporting a center post of the system.
